(19) United States
(12) Patent Application Publication
(10) Pub. No.: US 2001/0032144 A1
(43) Pub. Date: Oct. 18, 2001

(54) Method for the transfer of technology using a web-based technology management system

(76) Inventor: Thomas Magid, Rydal, PA (US)

Correspondence Address: Seidel, Gonda, Lavorgna & Monaco, P.C., Suite 1800, Two Penn Center Plaza, Philadelphia, PA, 19102, US

(21) Appl. No.: 09/757,661

(22) Filed: Jan. 10, 2001

Related U.S. Application Data
(60) Provisional application No. 60/175,618, filed on Jan. 11, 2000.

(51) Int. Cl. G06F 17/60

(52) U.S. Cl. 705/26; 705/37

(57) ABSTRACT

A computerized, network-based technology management system and method that delivers qualified prospects to a seller or purchaser of proprietary intellectual property, which may be, but is not limited to patents, trademarks, and copyrights. This networks and methods interest, encourage and retain qualified prospective purchasers to progress through successively restricting levels and fulfillment of demands of an owner or licensor of intellectual property. As the demands of each viewing level are met by a qualified prospective purchaser, that prospective purchaser is viewed and rated by successively more stringent security techniques, which authenticate and verify the qualifications of the prospect.

### CROSS REFERENCE TO RELATED APPLICATION

This application claims priority to provisional application 60/175,618 filed Jan. 11, 2000.

### FIELD OF THE INVENTION

The method of the invention relates to a web-based technology management system and method of use that delivers qualified prospective licensees or purchasers to a licensor or seller of proprietary intellectual property, which includes but is not limited to patents, trademarks and copyrights.

### BACKGROUND

Traditionally, an owner of intellectual property had a limited number of avenues to bring intellectual property to the market place. One such way was simply to manufacture and market the intellectual property such as a patent himself. However, this is not practical or possible for many owners because of the enormous cost of production and distribution, limited geographic exposure, or simply lack of familiarity with markets other than their own.

Another way to reach the market place was to approach prospective licensors personally or via intellectual property marketing firms. Approaching prospective licensors oneself is both time consuming and expensive in terms of travel, personalized contacting, and conventional communication channels.

Most marketing firms charge a fee to the owner of the intellectual property to present some form of disclosure to prospective purchasers or licensees. The disclosure may be sent via mass mailing or by a traveling representative. In this case, prospective purchasers or licensees are able to view the property at no cost and no commitment and the owner pays all the bills. This is not in the best favor of the owner because there is no way to determine whether the purchaser is serious or simply curious. This method of marketing the intellectual property also is slow and limited in its exposure to prospective purchasers or licensees.

More recently, internet-based intellectual property marketers have come into existence to disseminate intellectual property on the web. However, these marketers also present some form of disclosure of the property to the public purchaser at a de minimus, tangential, or no cost and the owner has no way of sorting out the serious onlookers from the curious.

Therefore there is a need for an intellectual property/technology marketing method to serve owners that is fast, global and that can effectively and efficiently deliver qualified and serious prospective purchasers or licensees to the owner. There is also a need to implement high levels of security during the viewing process to assure the owner of the desired confidentiality of the information being transmitted. There is also a need to fulfill an owner's imposed demands for viewing his intellectual property and to compensate him for his expenses in bringing the intellectual property to the viewing marketplace.

Therefore, it is an object of the present invention to allow owners to interest, retain and encourage a qualified prospect(s) to progress through successively restricting levels of viewing his intellectual property and to fulfill demands of the owner of the intellectual property.

It is also an object of the present invention to allow owners to review and rate prospective purchasers as his demands for each viewing level are met and to impose successively more stringent security techniques to authenticate and verify the qualifications of the prospective purchaser.

The present networks and methods may also be used in a more conventional manner, where the seller entices purchasers by incurring obligations to the network operator and/or purchaser for the right to display the intellectual property in successive levels of increasing detail. In this way, a purchaser may evaluate a seller's offering and identify those sellers seriously wishing to convey their intellectual property.

Alternatively, both the seller and purchaser may require consideration from the other for access to or display of successive levels.

These and other objects of the invention are set forth in the following description of the invention and in the accompanying drawings. The novelty will be apparent to those skilled in the art of marketing intellectual property.

### SUMMARY OF THE INVENTION

These objects are fulfilled by the computerized networks and methods of the present invention, which in one aspect is network-based, preferably web-based, technology management and marketing system and process wherein the traditional role of the purchaser and seller are reversed. The purchaser (licensee), whose role traditionally does not require payment or consideration before evaluation of the actual product or process, must in this case progress through a carefully designed marketing process, assume obligations in the form of payments or other consideration, and signed agreements. This occurs as the purchaser progresses through increasingly more rigorous stages of evaluating a licensor's proprietary intellectual property.

For instance, in a case where there are three viewing stages (see FIG. 1), the first stage that could be termed a surfer stage, would allow rudimentary keyword viewing in exchange for identification and a pin number. The second stage, more sophisticated viewing of technology, may require the purchaser, who is now trying to promote his worthiness of viewing higher levels of disclosure, to sign a disclosure agreement as to his resources, capabilities, use of the technology, or other such disclosures which may lead to certificate authentication. The third stage, exchanging even more sophisticated viewing, may require the ultimate purchaser, who is now assuming the sellers traditional psychology of having to qualify and provide his worthiness to buy, to sign a non-disclosure, non-usage agreement, or even a non-compete agreement with the owner/licensor of the technology or with the web-based marketing company providing the service of bringing sellers and purchasers together on the internet. This third viewing stage may further be divided into levels of security requiring increasingly stringent levels of purchaser identification or monies paid to achieve successively higher levels in the viewing and evaluating process, which may include an audio/visual presentation/demonstration of the highest levels including know-how transmittals to a now qualified and highly interested potential purchaser/user of the intellectual property.

This increasingly more rigorous marketing process requires an exchange for consideration at every level, forcing the traditional purchaser into a seller role by requiring the purchaser to prove himself by more than mere monetary commitment, which is traditionally a sellers mentality.

As a result of the method of the invention, the traditional seller/licensor who would normally expect to pay, or struggle through a sales process, receives consideration in the form of such things as identification, levels of certificate authentication, monies, agreements, or other valuable consideration in exchange for simply revealing stages of completion or know-how of his proprietary intellectual property.

The method of the invention thus involves flow through multi-levels. The method of the invention delineates and eliminates the curious and undesirable prospects at each viewing level by extracting consideration to encourage commitment. The method of the invention provides security and certificate authentication. The method engages in reversing the traditional purchasers/sellers role insofar as, in the viewing process, the purchaser proves his qualification by, for example, paying for a presentation and demonstration prior to the purchase of any product or license to possibly a third party, which is not a broker in the traditional sense. The presenter may or may not share in the commitment of the purchaser.

The invention also provides computerized networks for implementing the above-described methods. In one embodiment, the computerized network comprises a closed “intranet” system. In a preferred embodiment, the computerized network of the invention comprises a global, publicly accessible network such as the internet or wireless web.

The invention also provides computer program products comprising a computer useable medium having program logic stored thereon, wherein said program logic comprises machine readable code to enable a computerized network to perform the technology management and marketing methods of the invention.

The networks and methods of the invention may also be used to facilitate the more traditional interaction between a purchaser and seller of intellectual property. In this aspect, the seller entices the purchaser to view levels of disclosure regarding the intellectual property being offered by providing consideration to the purchaser at each level.

In a further aspect, the present networks and methods may be used where consideration is provided by both the seller and purchaser. For example, an initial offer of consideration may originate from the seller. Once a prospective purchaser is attracted, the seller may require consideration from the purchaser before the purchaser can view the next level.

### BRIEF DESCRIPTION OF THE DRAWINGS

FIG. 1 is a flow diagram of a method of the invention.

FIG. 2 is a flow diagram of the operation of an exemplary network.

FIG. 2a shows an exemplary L1 search screen.

FIG. 2b shows an exemplary request for information to cross B1.

FIG. 2c shows an exemplary L2 information display.

FIG. 2d shows an exemplary qualifying/screening questionnaire.

### DEFINITIONS

As used herein, “intellectual property” includes any proprietary information relating to a particular subject or technology, including, but not limited to, patents, trademarks, copyrights, trade secrets and know-how.

A “seller” is any party who possesses intellectual property and wishes to sell it through the network, whether or not a transaction for that intellectual property ultimately takes place. As used herein, a sale of intellectual property includes any transfer of rights for consideration, for example through a licence or assignment of rights.

A “purchaser” is any party who wishes to purchase intellectual property through the network, whether or not a purchase of intellectual property ultimately takes place. As used herein, a purchase of intellectual property includes any acquisition of rights for consideration.

### DETAILED DESCRIPTION OF THE INVENTION

The computerized networks and technology management and marketing processes of the invention facilitate the marketing and exchange of intellectual property. This is accomplished by allowing the sequential evaluation of the offered intellectual property, driven by the request for consideration prior to viewing successive levels of increasing complexity. The consideration may be requested by either the seller or purchaser, or both. The consideration may also be requested by the network on behalf of either the seller or purchaser. In a preferred embodiment, the methods permit the inversion of the traditional role of purchaser and seller, where the purchaser is required to provide consideration for the privilege of viewing each successive information level. The following describes the networks and methods for the present technology management and exchange.

The present networks and methods are particularly suitable for internet application due to the speed and breadth available on a global network. However, it is understood that the present methods may be implemented by any computerized network; including, for example, private and public computerized electronic networks such as the internet or the wireless web, open networks where the user simply dials in, and dedicated intranets comprising a closed system of remote users and a central server/data repository. A convenient and most preferred computerized network is the internet, where access to the network preferably occurs through a central network website.

Generally, the networks of the invention comprise a network central or “core” site, for example a central server or CPU, and at least one “seller” and at least one “purchaser” who make use of the network to market or exchange intellectual property.

The network core site provides the medium through which purchasers locate and view available technology, and interact with the network and sellers for the ultimate acquisition of that technology. For example, the network core site stores information relating to sellers' technology and allows purchasers to find information regarding technology of interest to them. As explained more fully below, purchasers may then access that information in a stepwise manner through viewing levels of increasing complexity, in exchange for specified consideration at each level. The network core may also provide both purchasers and sellers with peripheral services relating to the marketing or exchange of intellectual property, including but not limited to assistance with capital sourcing, marketing consultation, news/bulletin board services, and legal services.

The network core site may comprise at least one computer, at least one storage medium (such as a disk drive), and the components and software necessary to interface with computers or other electronic devices at remote locations. The computer(s) of the network core site may be an internet network server. The network core site coordinates the input, storage and exchange of information from computers and other electronic devices located with the purchasers and sellers who are connected to the network.

The computer(s) of the network core site further comprise at least one database stored on storage medium, which database includes information relating to the exchange of technology on the network. Such information may be input directly by purchasers or sellers, or may be acquired as a by-product of purchaser and/or seller activity on the network. An example of information which is input directly includes information relating to seller proprietary technology, or information relating to details of a purchaser's business or organization. Information acquired as a byproduct of purchaser or seller network activity includes, for example, the correlation of technology viewed with the size/character/location of purchaser, the level to which a purchaser or class of purchaser progressed, and details of the ultimate arrangements for technology transfer in certain technology areas.

The at least one purchaser and at least one seller on the network each has access to at least one computer or other electronic device capable of connecting to and communicating with the network core site. It is preferred that purchasers and sellers connect with the network core site via the internet.

The computers comprising the computerized electronic networks of the present invention can store and execute machine readable code comprising computer program logic (i.e., software or computer programs) which enables a computer to perform network functions. Network functions include: the exchange, storage and organization of information; network administrative functions; interacting with purchasers as they progress through the viewing levels; communication with purchasers and sellers; and peripheral services.

The invention thus also provides computer program products comprising a computer readable medium having computer program logic which enables a computer to perform a given network function. The computer readable media can be integral to the network computers (e.g., an internal hard drive) or external to the network (e.g., a tape, “floppy” disk, compact disc, or other portable computer readable medium).

The computerized networks of the invention allow the implementation of the present technology management and marketing methods, which are designed to encourage the purchaser to progress through several secure viewing phases. The methods of the invention encourage flow through a multi-level viewing process, while at the same time limiting disclosure to those not involved in the progression of the process. In addition, as the purchaser progresses through the levels, increased security devices assure qualification to the parties of both the viability and authenticity of the seller or purchaser.

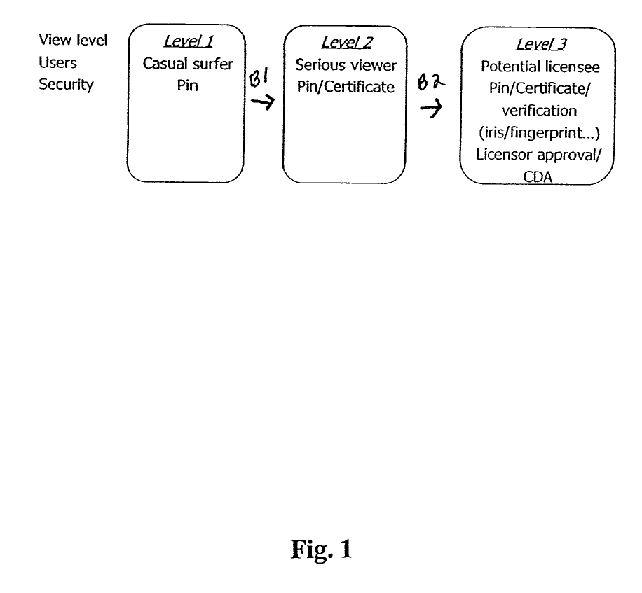

A purchaser interested in procuring proprietary intellectual property will pass through a plurality of viewing levels, preferably two to five viewing levels, and more preferably three viewing levels. A preferred three-level viewing system, in which the seller requests consideration from the purchaser, is given in FIG. 1.

The following description will focus on those methods and networks in which consideration is requested of, and provided by, the purchaser in order to view successive levels.

Each viewing level involves greater degrees of security (certification), increasing parameters of qualification and successively greater degrees of commitment from the seller purchaser (usually but not necessarily monetary). Once the qualified purchaser reaches the final level of viewing he can be delivered to the seller or delivered into what is now known as a chat room or secured subspace of the network for monitored or supervised further negotiations or qualifications between the seller and the purchaser. At any one of the viewing levels, the seller may become aware of the identity of the qualified prospective purchaser, and may choose or not choose to reject any further progression through the viewing levels by the qualified prospective purchaser. Simultaneously, the purchaser may or may not be aware of the seller at the discretion of the seller.

Security: Each successive level of viewing will be accompanied by a successively more stringent certificate of authority, which encompasses identification, authentication, and certification of the purchaser. Security techniques for verification may include but are not limited to personal identification numbers, iris scan technology, fingerprint technology, voice scan technology, public key encryption technology, visual or photo scan technology, etc. Certificate authority may be provided either internally or through a strategic alliance operating in concert with the primary provider of this marketing method over the global network or a marketing arm thereof. The successively more stringent security systems are an integral part of the present process.

Qualification: Each prospective purchaser will be requested to provide qualifications in the form of demands for consideration, the parameters of which will be specified and delineated by the seller. In this manner, the purchaser will be qualified or not qualified to progress to the next level. Only a qualified purchaser will be able to pass through each successive level of viewing.

Commitment: In order for the purchaser to flow through each successive and stringent viewing level, the purchaser will impart at each viewing level some form of commitment. This includes, but is not limited to, the following: monetary consideration, standard client disclosure agreements, more stringent non-disclosure/non-usage agreements, standard non-compete agreements, demographic agreements, geographic agreements, and other specific restricting or limiting agreements.

The present invention thus provides a method of using a computerized network to interest and retain at least one qualified purchaser of intellectual property through levels of disclosure and requests that demands be met by the purchaser before each successive level of disclosure is made. This exchange of levels of presenting of the invention and the fulfillment of the demands of the seller by the purchaser optimally will result with a signed contract relative to the intellectual property after the one or more levels of disclosure and fulfillment of seller demands. The creation and use of such networks also facilitates the gathering of data relating to the purchase or licensing of intellectual property, which data may be valuable in devising optimal strategies for marketing intellectual property over the present networks.

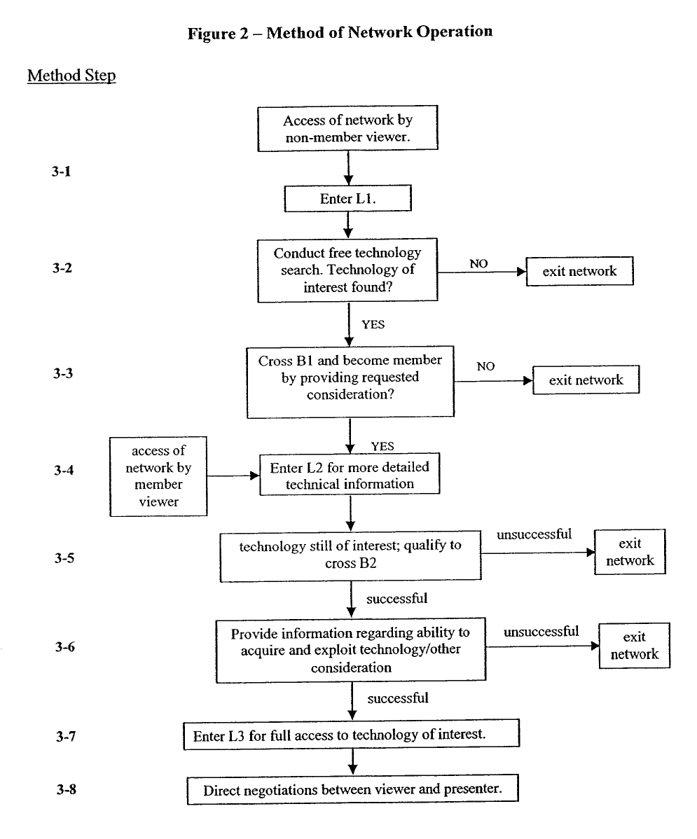

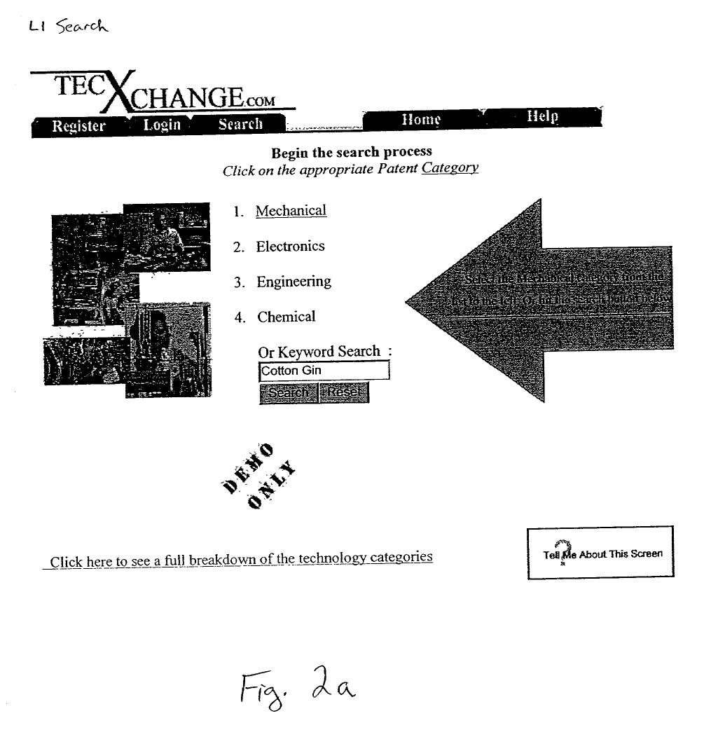

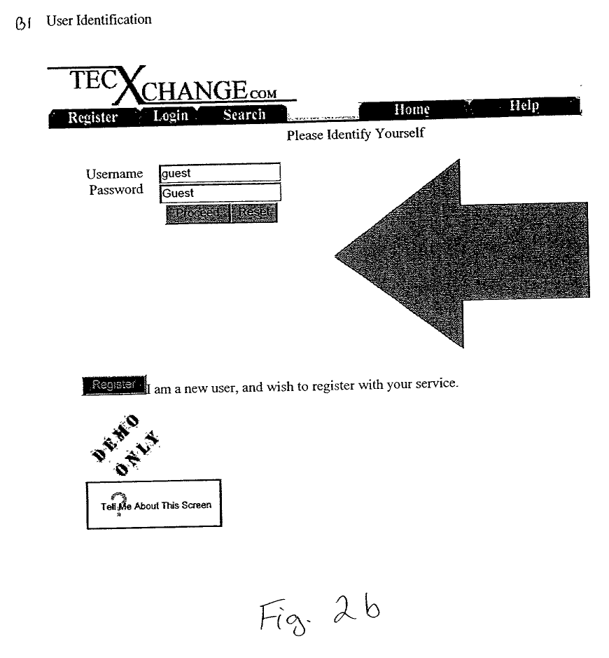

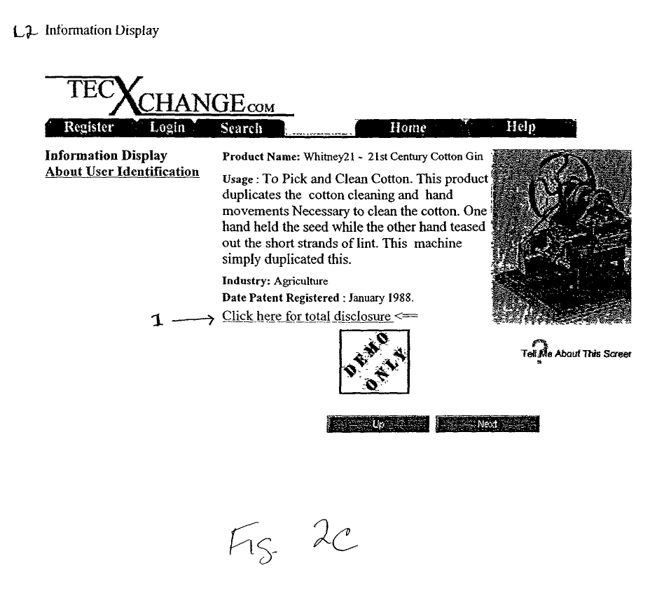

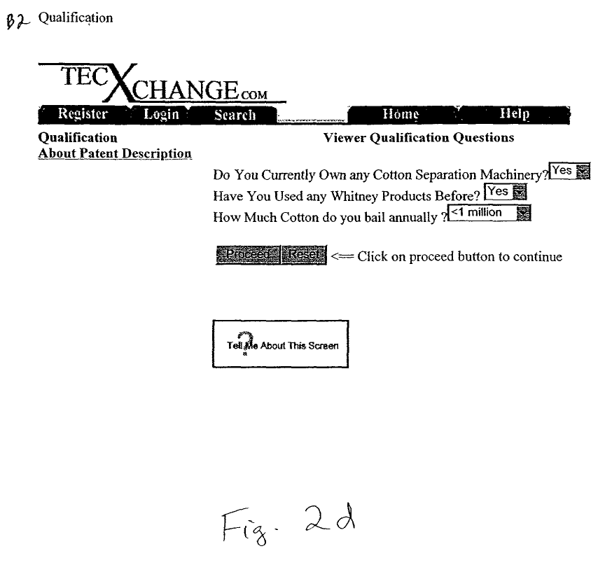

Operation of the network will be illustrated in FIG. 2 with the exemplary three-level system of FIG. 1. This exemplary system allows the purchaser to move thought three levels (L1, L2 and L3) and two “bridges” (B1 and B2) in the following order:

L1—Free technology search.

B1—Optional network membership/payment options.

L2—Detailed technology information.

B2—Bridge 2 qualification.

L3—Full access to technology information.

With reference to FIG. 2, in step 3-1 a non-network member purchaser accesses the core network website and enters L1. This level allows the casual purchaser to search for technology (step 3-2), for example by keyword, patent office SIPC numbers of technology available, basic categorical search, or other identifier. Only limited information about a technology is available at this level. An exemplary L1 search screen is shown in FIG. 2a.

If no technology of interest to the purchaser is found, the purchaser may exit the network or conduct another search. If technology of interest is found, the purchaser may decide to cross bridge B1 and become a member of the network (step 3-3).

B1 may incorporate, for example, a marketing piece to encourage casual purchasers to become serious purchasers through a membership in the network. Membership may be secured by delivery of some consideration from the purchaser, for example by providing an user number and password, or by executing a membership agreement including a nondisclosure agreement and a purchaser profile. The purchaser may also be asked to supply a monetary payment. If the purchaser does not wish to become a network member by providing the requested consideration, he may exit the network. An exemplary request for information to cross B1 is shown in FIG. 2b.

Should the purchaser choose to become a network member, he enters L2 (step 3-4). At this level, he gains access to more detailed information about the technology of interest. Available information may include a description of patents, trademarks, copyrights or other proprietary intellectual property posted on the network by sellers. This level may also provide a sales presentation focusing on the benefits (but not necessarily the specifics) of the technology, with detailed text, pictures, samples or other items normally associated with an initial sales presentation. Purchasers who have already become network members may immediately enter L2 at step 3-4 upon connecting to the network. FIG. 2c shows an exemplary L2 information display.

At the end of the Level 2 presentation, the network will indicate how purchasers who are still interested in the technology can proceed. For example, the network may offer the purchaser a full disclosure of the technology (see item 1 in FIG. 2c). Alternatively, if a seller has elected not to allow a full disclosure at the discretion of the purchaser, the network may direct purchaser information to the seller so that the seller may decide whether to allow the purchaser to proceed further.

If the purchaser wishes to, or is permitted to, proceed past L2 he must then satisfy an initial qualifying/screening device (step 3-5) administered by the network on behalf of the seller. The qualifying/screening device may comprise, for example, a questionnaire or set of parameters that must be met by the purchaser. Preferably, the network assists the seller in creating the qualifying/screening device. An exemplary qualifying/screening questionnaire is shown in FIG. 2d.

Once the qualifying/screening device is completed by the purchaser, there is preferably a period (for example, one business day) during which the seller decides whether to let the purchaser proceed (i.e., “cross the bridge”) to L3. The qualifying/screening device may be completed without the seller knowing the purchaser's identity.

If the purchaser qualifies to cross B2, the network will then require the purchaser to identify himself and provide certain other information relating to his ability to acquire and exploit the technology (step 3-6). A monetary payment may also be required. A purchaserwilling to provide the required consideration may, at the discretion of the network and/or seller, cross B2 and proceed to L3 (step 3-7). The identity of the seller may or may not be known to the purchaser at this stage.

At the L3 level, the purchaser will have access to detailed information regarding the technology of interest. This may consist of, for example, an audio-visual demonstration or presentation. The network may assist the sellers in creating the L3 presentations. The identity of the seller would be disclosed to the purchaser on completion of the Level 3 demonstration, unless otherwise noted by the licensor, and purchaser and seller may then engage in direct negotiations for the technology (step 3-8), either in person or over the network.

In another embodiment, the roles of seller and purchaser described above may be reversed, and consideration is provided by the seller prior to viewing each level of disclosure. The consideration may originate from the seller; for example a blanket offer to provide more information simply by progressing to the next viewing level. The consideration may also be required by the purchaser; for example, as a specific request from a purchaser for information regarding the intellectual property and/or vital statistics of the seller. The consideration may also be required by the network itself on behalf of the purchaser, and may be provided to either the network or the purchaser.

For example, after completing an initial search for intellectual property of interest, purchasers may request more information from sellers with regard to that intellectual property, or about the seller himself, before agreeing to progress to the next level. The requested consideration may also comprise a monetary payment. Alternatively, sellers of intellectual property may access and search the network for prospective purchasers who have indicated an interest in a particular field. The purchasers found in the search are then enticed to progress through the viewing levels by the delivery of consideration from the seller.

The seller and purchaser may also engage in mutual requests for consideration. For example, once a purchaser conducts an initial search, he may require further disclosure or other consideration from the seller before committing to view the next level. Likewise, the seller may request more information (such as completing a qualifying questionnaire) before agreeing to let the purchaser progress. The mutual requests for consideration may be sequential (i.e., purchaser first, seller next, etc.) or simultaneous. At any stage, either party may discontinue the interaction by refusing to request or deliver further consideration.

The networks, methods, and computer program products of the present invention are not limited to the examples recited herein. Having thus described in detail preferred embodiments of the invention, it is to be understood that the invention defined by the appended claims is not to be limited by particular details set forth in the above description as many variations thereof are possible without departing from the spirit or scope of the present invention.

What is claimed is:

1. A computerized network for interesting and retaining at least one qualified purchaser or licensee of intellectual property, comprising:
(1) at least one seller;
(2) at least one prospective purchaser; and
(3) a central network core site comprising at least one computer and at least one storage medium, through which:
(i) the seller presents a first level of disclosure of said intellectual property to the purchaser and requests a first response, said first response comprising a fulfillment of a first demand by the purchaser;
(ii) the purchaser fulfills the first demand;
(iii) the seller presents a second level of disclosure of said intellectual property to the purchaser and requests a second response, said second response comprising a fulfillment of the second demand by the purchaser;
(iv) the purchaser fulfills the second demand; and
(v) the seller and the purchaser optionally enter into a contract relative to the intellectual property.

2. The network of claim 1, through which the seller presents additional levels of disclosure comprising requests for additional responses, said additional responses comprising fulfillment of additional demands, wherein the purchaser fulfills said demands before entering into the contract.

3. The computerized network of claim 1, wherein said contract is a licensing agreement.

4. The computerized network of claim 1, wherein said contract is an assignment of rights.

5. The computerized network of claim 1, wherein said intellectual property is selected from the group consisting of a patent, a trademark, a copyright, a trade secret and know-how.

6. The computerized network of claim 1, wherein each successive level of presenting has associated therewith an increasing level of security.

7. The computerized network of claim 1, wherein said demands comprise compensation comprising one or more of money, certificate authentication, or agreements.

8. The computerized network of claim 1, wherein each level of said presenting comprises revealing additional information relating to said intellectual property.

9. The computerized network of claim 1, further comprising peripheral services relating to the marketing or exchange of intellectual property offered through the network core site.

10. A method of using the computerized network of claim 1 to interest and retain at least one qualified purchaser of intellectual property comprising:
(a) a seller presenting a first level of disclosure of said intellectual property to the purchaser via said network and requesting a first response, said first response comprising a fulfillment of a first demand by said purchaser;
(b) said purchaser fulfilling said first demand via said network;
(c) said seller presenting a second level of disclosure of said intellectual property to the purchaser via said network and requesting a second response, said second response comprising a fulfillment of a second demand by said purchaser;
(d) said purchaser fulfilling said second demand via said network; and
(e) said seller and said purchaser optionally entering into a contract relative to said intellectual property.

11. The method of claim 10, further comprising additional presenting of levels of disclosure by the seller comprising requests for additional responses, said additional responses comprising fulfillment of additional demands, wherein the purchaser fulfills said demands before entering into the contract.

12. The method of claim 10, wherein said contract is a licensing agreement.

13. The method of claim 10, wherein said contract is an assignment of rights.

14. The method of claim 10, wherein said intellectual property is selected from the group consisting of a patent, a trademark, a copyright, a trade secret and know-how.

15. The method of claim 10, wherein each successive level of presenting has associated therewith an increasing level of security.

16. The method of claim 10, wherein said demands comprise compensation comprising one or more of money, certificate authentication, or agreements.

17. The method of claim 10, wherein each level of said presenting comprises revealing additional information relating to said intellectual property.

18. The method of claim 10 wherein the purchaser or seller access peripheral services relating to marketing or exchange of intellectual property available on the network prior to entering into the contract.

19. A computer program product comprising a computer usable medium having program logic stored thereon, wherein said program logic comprises machine readable code to enable the computerized network of claim 1 to interest and retain at least one qualified purchaser of intellectual property, wherein the machine readable code comprises:
(1) machine readable code to enable the seller to present a first level of disclosure of the intellectual property to the purchaser via the network and request a first response, said first response comprising a fulfillment of a first demand by the purchaser;
(2) machine readable code to enable the purchaser to fulfill the first demand;
(3) machine readable code to enable the seller to present a second level of disclosure of the intellectual property to the purchaser via the network and request a second response, said second response comprising a fulfillment of the second demand by the purchaser;
(4) machine readable code to enable the purchaser to fulfill the second demand; and
(5) machine readable code to enable the seller and the purchaser to optionally enter into a contract relative to the intellectual property.

20. The computer program product of claim 19 further comprising machine readable code to enable the network core site to perform peripheral services relating to the marketing or exchange of intellectual property.

21. The network of claim 1, wherein the first and second responses are requested by the purchaser and comprise fulfillment of a first and second demand by the seller, and the seller fulfills the first and second demands.

22. The network of claim 21, wherein the purchaser requests additional responses from the seller to view additional levels of disclosure, said additional responses comprising fulfillment of additional demands by the seller, wherein the seller fulfills said demands before entering into the contract.

23. The method of claim 10, wherein the first and second responses are requested by the purchaser and comprise fulfillment of a first and second demand by the seller, and the seller fulfills the first and second demands.

24. The method of claim 23, wherein the purchaser requests additional responses from the seller to view additional levels of disclosure, said additional responses comprising fulfillment of additional demands by the seller, wherein the seller fulfills said demands before entering into the contract.

25. The computer program product of claim 19 wherein the machine readable code enables the first and second responses to be requested by the purchaser and fulfilled by the seller.

26. The network of claim 1, wherein the purchaser also requests a response from the seller comprising fulfillment of a demand by the seller prior to the presentation of each level of disclosure.

27. The network of claim 2, wherein the purchaser also requests a response from the seller comprising fulfillment of a demand by the seller prior to the presentation of each level of disclosure.

28. The method of claim 10, wherein the purchaser also requests a response from the seller comprising fulfillment of a demand by the seller prior to the presentation of each level of disclosure.

29. The method of claim 11, wherein the purchaser also requests a response from the seller comprising fulfillment of a demand by the seller prior to the presentation of each level of disclosure.

30. The computer program product of claim 19 further comprising machine readable code to enable the purchaser to also request a response from the seller comprising fulfillment of a demand by the seller prior to the presentation of each level of disclosure.
